(19) United States
(12) Patent Application Publication
(10) Pub. No.: US 2024/0393160 A1
(43) Pub. Date: Nov. 28, 2024

(54) CONTAINER AND CONTAINER FRAME

(71) Applicant: MULTIPOND Wägetechnik GmbH, Waldkraiburg (DE)

(72) Inventors: Andreas PETERS, Aschau am Inn (DE); Julian SCHICK, Zangberg (DE)

(21) Appl. No.: 18/669,400

(22) Filed: May 20, 2024

(30) Foreign Application Priority Data
May 24, 2023 (EP) 23175185.0

(51) Int. Cl. G01G 21/22

(52) U.S. Cl. CPC G01G 21/22

(57) ABSTRACT

The present invention relates to containers, in particular used as storage or weighing containers for combination scales. A container according to the invention includes a frame. The frame is produced from a metal material, and the frame has no welding connections. By using a casting method, cost-effective production, but nevertheless hygienically suitable design, is possible.

### CROSS-REFERENCE TO RELATED APPLICATIONS

This application claims priority to European Patent Application No. 23 175 185.0 filed on May 24, 2023, and entitled CONTAINER AND CONTAINER FRAME, the contents of which is herein incorporated by reference in its entirety.

### FIELD OF THE INVENTION

The present invention relates to a container, in particular for a scale, for example a combination scale. In particular, the focus is on the frame of this container, which is made of metal, but without using welding connections.

### BACKGROUND

In the prior art, a combination scale is known from document EP 1 166 057 B1. Here, products are conveyed from a distributing device by feeding them before they fall into corresponding storage containers or then into corresponding weighing containers. Subsequently, products are collected by a collecting device. Important for corresponding storage or weighing containers are in particular the frames, i.e. the base bodies of the corresponding storage or weighing containers, since these collect the products to be weighed and—if used as a weighing container—the weighing process is also carried out in these.

In the prior art, for example, frames made of welded sheet metal are known-however, in the case of scales for foodstuffs, a hygiene-friendly design must be present, for this reason, for the shaping of the containers, a sheet metal with a smooth surface must be used, which must be welded, for example by a laser welding method.

This means a very high set-up and adjustment effort and the laser beam, which carries out the welding process, must be very thin. Nevertheless, it must be possible to work gap-free, i.e. no gaps must arise in which dirt, cleaning agents or the like could accumulate.

A hygiene-friendly design is thus possible only with very high effort on account of the production-related restrictions.

Furthermore, heat distortion can occur during welding, which could distort the entire component. There is also always a certain risk of open welding connections, as a result of which cavities arise. In these cavities, microorganisms and cleaning agent residues can settle and cause contamination on exit. In the case of the welding method used, in addition, a very movable laser head must be used in order to reach all points, since in the case of a container everything must be welded tightly all around. This causes very high costs.

Since further components have to be welded to the frames (suspension of the container, suspension of the flaps, etc.), additional welding connections are also present on a corresponding frame.

Furthermore, containers and container frames consist of plastic, but these cannot be used for all applications.

It is therefore an object of the present invention to provide metal frames for a container, by means of which the abovementioned disadvantages are overcome, and which can be produced cost-effectively

### SUMMARY OF THE INVENTION

This object is achieved by a container according to claim 1 and a combination scale according to claim 12 and a method according to claim 14. Further advantageous embodiments of the present invention are the subject matter of the dependent claims.

The container according to the invention has a frame which is produced from a metal material. Furthermore, the frame has no welding connections at all. Only in this way can all the abovementioned disadvantages be overcome, since welding does not have to be carried out. In addition, such a production method is significantly more cost-effective. Such a container serves, for example, as a storage or weighing container of a scale, in particular a combination scale.

The frame is preferably produced from a ductile metal material, more preferably from stainless steel. This allows hygienically designed surfaces and high stability.

The frame is preferably produced by a primary forming method, more preferably a casting method, even more preferably a precision casting method. In such a method, in particular a precision casting method, all the parts of the frame and of the associated further components can be produced by casting material; there is thus no disadvantage that some parts have to be welded to the frame, as a result of which smears would have to be made in the hygienically suitable design.

More preferably, the frame has a duct-shaped section. A duct-shaped section encloses a space. It can have, for example, a rectangular, round or oval cross section. For example, the cross section can change over the height.

Preferably, furthermore, a section adapted to the flap shape is provided, which is attached to the duct-shaped section. The flaps bear against these and thus close the container.

For example, at least one obliquely tapering section is provided here, which is attached to the duct-shaped section. In one embodiment, two obliquely tapering sections are provided.

More preferably, the frame is formed in one piece.

The wall thickness of the frame is preferably in a range between 0.3 and 5 mm, preferably between 1 and 2.5 mm. Especially in the case of such wall thicknesses, it is advantageous to produce without welding connections, since especially when further parts are to be attached or welded to the frame, damage and cavities could occur here.

The average roughness of the frame surface is preferably at most 0.8 μm. This allows a hygienically suitable design.

More preferably, a surface structuring is provided in the inner region of the frame. More preferably, the surface structuring is diamond-shaped.

Such a surface structuring can lead to products, such as, for example, jellybears, chocolate sweets or the like, adhering more poorly to the frame, for which reason, during a weighing process, all products can be poured out of the corresponding container without products adhering to the container, and thus weighing results cannot be falsified. However, such a surface structuring is expedient only in the inner side of the frame, since only the inner side of the frame is directly in contact with products.

The casting method here allows the surface structuring to be provided only partially, i.e. only the inner side of the frame can be provided with a surface structuring, but not the outer side. The surface structuring can be produced during the casting, i.e. already during the primary forming process.

More preferably, at least one flap fastening device is provided on the outer side of the frame. A corresponding container flap can be attached to this.

In order that better stability is present, preferably two flap fastening devices are provided per container flap.

If two flaps are present, for example four flap fastening devices are provided on the outer side of the frame.

The flap fastening device has a section projecting from the frame, and preferably this has in each case an interface (here: bore) in which the fastening of the flaps can be received.

A corresponding container without welding connections, which is thus produced by casting (preferably precision casting), has the advantage that the flap fastening device(s) does/do not have to be welded on extra, but can be cast in at the same time. They are thus formed integrally with the frame per se.

More preferably, the flap fastening device(s) is/are provided at the transition from the duct-shaped section to the section adapted to the flap shape.

More preferably, the frame has at least one suspension device.

More preferably, it has at least two suspension devices, and more preferably the suspension devices have in each case a bearing point (for example bore). Even more preferably, at least one suspension device has a cylindrical section with which the frame can be suspended on a corresponding holding device.

A restoring spring can also be tensioned against this cylindrical section.

The suspension device is thus also a component which has to be welded to the frame in a conventional process—in the case of a weld-connection-free frame, however, this is not necessary, and the suspension devices (with their partly filigree structures) are formed integrally with the frame.

More preferably, the transitions between the outer side of the frame and the flap fastening device and/or a suspension device have a radius of at least 6.5 mm. This is advantageous in order to be able to carry out a hygienically suitable design accordingly.

If such a suspension device or a flap fastening device had to be welded to the frame, a large amount of material would have to be introduced into the connection here during the welding process, but this constitutes a problem since holes could thus be very easily burnt into the metal sheet of the frame. Bearing points and eyelets therefore now have to be neither welded nor screwed, and during casting, the realization of filigree components or components is also completely unproblematic.

More preferably, a container has: at least one flap which is adapted to close the lower opening of the container, the flap being mounted pivotably on at least one, preferably two flap fastening device(s). The at least one flap is connected by a flap actuating mechanism to a rotary shaft, the rotary shaft being mounted in the bearing point(s) of the suspension device. A closing mechanism for the container can thus be realized. Preferably, two flaps are provided, these are then connected to one another by a connecting element.

More preferably, the flap(s) bear against the part/parts of the section adapted to the flap shape, for example obliquely tapering section. The container can thus be closed well.

More preferably, the movement of the flap actuating mechanism upwards is limited by a limiting section which is likewise formed integrally with the frame. This limiting section also therefore does not have to be welded on, but can be formed primarily by casting.

More preferably, the frame has a greater wall thickness in the region in which the suspension devices are provided than in other regions. This contributes to a torque-compliant construction since most material is present in the region in which the torques applied to the frame are greatest (i.e. at the interface with the suspension device) and the strength is therefore greatest. The stiffness during handling can also be improved, which is important if, for example, the containers are removed during cleaning and fall down in the process. There is therefore less risk here that frames and components attached to them could be damaged when falling down.

A combination scale according to the invention comprises: a plurality of weighing containers and optionally storage containers which are formed as described above; and a collecting device which is adapted to bring together products from the weighing containers, wherein the weighing containers are adapted to record a weight signal over time.

Preferably, the combination scale is furthermore provided with a distribution plate and a plurality of metering channels, which are provided in each case with a drive. These components are arranged above the weighing containers.

The use of containers according to the invention has the further advantage that the transient response can be improved.

Since the frame is formed in one piece, the natural frequency of the frame is significantly higher (compared with a welded frame). Dynamic value detection of a weighing signal is faster and more accurate when the measured value transmitter does not have low natural frequencies. This also has significant advantages in the filtering of weighing signals. The frame according to the invention therefore contributes less to the oscillation at low frequencies in the overall system. Furthermore, the impact pulse of product generally causes the entire system to oscillate. At higher (natural) frequencies, such an oscillation comes to a halt more quickly, since the oscillation energy is used up more quickly at higher natural frequencies. Oscillations can therefore be damped more quickly and the negative effects of the impact pulse on the value detection decay more quickly.

Container frames without welding connections therefore also have significant advantages during the weighing process.

A method according to the invention for producing a frame of a container comprises the following steps: a) providing an outer casting mold which images the outer surface of the frame; b) providing a casting core adapted to image the inner surface of the frame; c) arranging the casting core in the outer casting mold; d) filling the outer casting mold with material (i.e. liquid metal).

A container frame can thus be produced in a primary forming manner easily and cost-effectively.

Further preferably, a surface structure is provided at least partially on the casting core.

In particular, it can thus be ensured that the inner side of the frame has a different surface structure than the outer side of the frame. By replacing the casting core, a different surface structure on the inner side of the frame can be very easily realized, without a complicated manufacturing process having to be redesigned here.

Exemplary embodiments of the present invention are described in more detail below by the accompanying figures.

### BRIEF DESCRIPTION OF THE DRAWINGS

FIG. 1 shows an isometric view of a first embodiment of a frame according to the invention.

FIG. 2 shows a side view of a frame according to the invention according to the first embodiment.

FIG. 3 shows an isometric view of a frame according to the invention according to the first embodiment with a specific surface structure.

FIG. 4 shows a similar view to FIG. 3, only with a different surface structure.

FIG. 5 shows a rear view of a frame according to the invention according to the first embodiment.

FIG. 6 shows a complete container according to the first embodiment.

FIG. 7 shows a detail of the corresponding suspension device.

FIG. 8 shows a detail of a flap fastening device.

FIG. 9 shows the attachment of a flap fastening device, a suspension device, and a limiting section.

FIG. 10 shows an overall view of a combination scale.

FIG. 11 shows an isometric view of a second embodiment of a frame according to the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

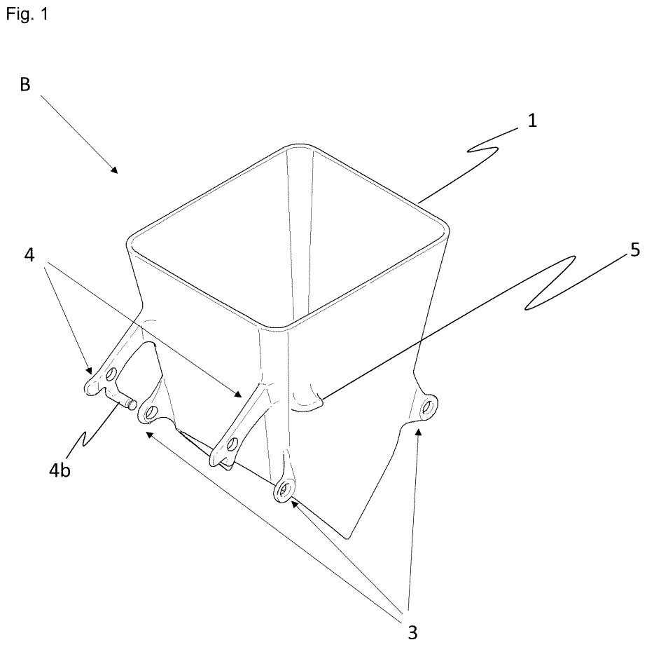

FIG. 1 shows a frame 1 of a container B according to the first embodiment. The container frame is configured from precision casting. Flap fastening devices 3, to which flaps (not shown here) can be attached, are provided on both sides on the outer side of the frame 1. Furthermore, two suspension devices 4 are provided on one side of the frame. A suspension device 4 has a cylindrical section 4b (to which, for example, a restoring spring—not shown here—can be fastened).

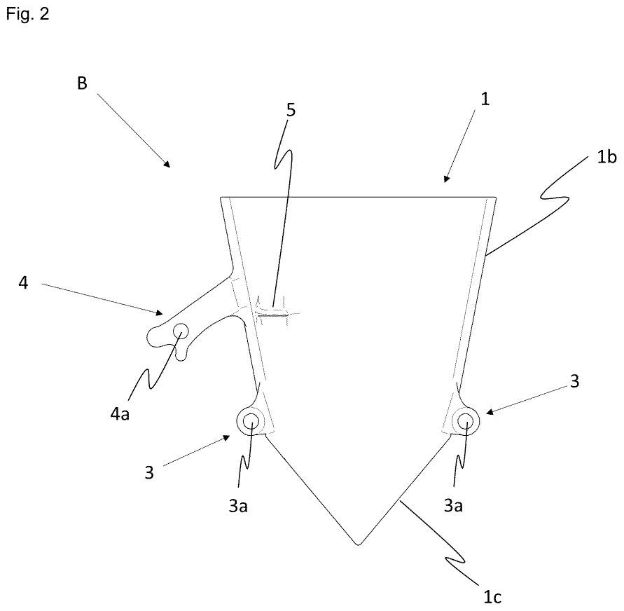

FIG. 2 shows a view of a frame 1 of a container B from the side. Here, an upper part (duct-shaped section 1b) of the frame 1 is square or cube-shaped, a lower part (section 1c adapted to the flap shape) is prism-shaped with two tapering parts. Also here, the flap fastening devices 3 can again be seen, in which an interface (here: bore) 3a is respectively provided. Furthermore, a further suspension device 4 is provided here, a bearing point (here: bore) 4a is also provided here. It can also be seen that a limiting section 5 is formed integrally with the frame 1.

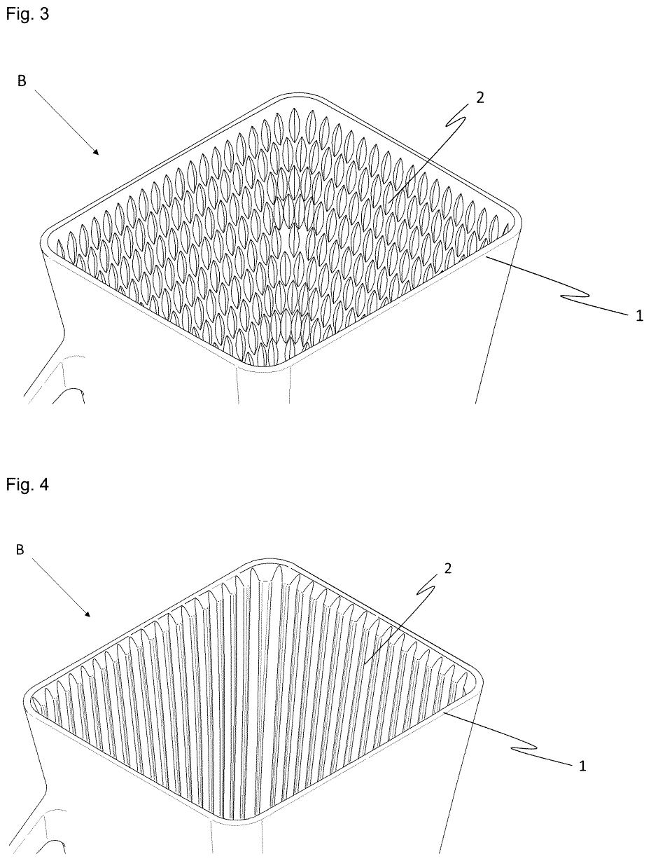

FIG. 3 shows the inner side of the frame 1 of a container B, here with a diamond-shaped surface structuring 2 on the inner side.

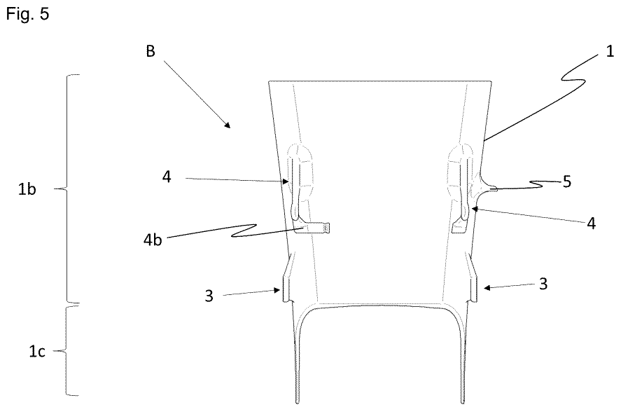

In FIG. 4, as an alternative embodiment to the embodiment shown in FIG. 3, a vertically ribbed surface structuring 2 is provided on the inner side of the frame 1.

FIG. 5 shows a rear view of a frame 1 according to the invention. It is shown here that a duct-shaped section 1b is present further above, and two acute-angled sections 1c are attached further below. Again, the flap fastening devices 3 and the suspension device 4, furthermore a limiting section 5, are shown. A cylindrical section 4b is attached to the suspension device 4.

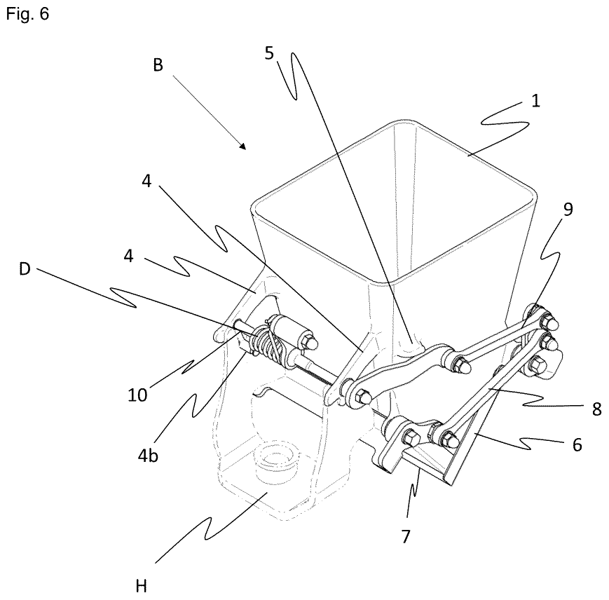

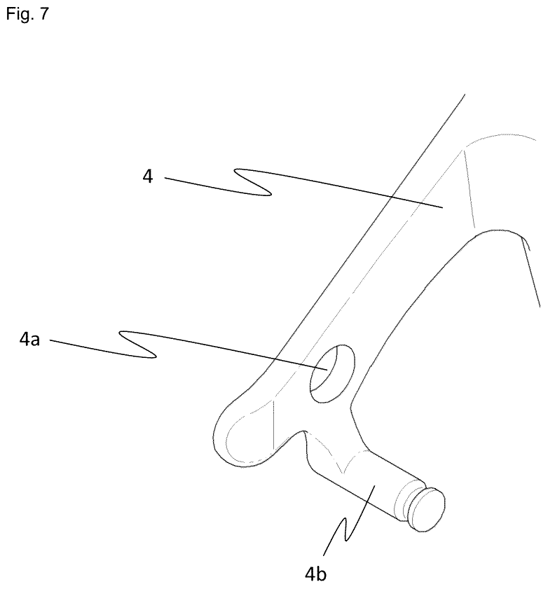

FIG. 6 shows a complete container B. The frame 1 is formed as described above. Furthermore, in each case a first flap 6 and a second flap 7 are provided, which limit the outlet of the container B downwards. The two flaps 6 and 7 are connected to a connecting element 8, the second flap 7 is additionally connected to a flap actuating mechanism 9, which connects these to a rotary shaft 10. The rotary shaft 10 is mounted in a pair of suspension devices 4. Furthermore, a holding device H is shown. The two flaps 6 and 7 can be opened and closed by the movement of the rotary shaft 10. A spring D, which serves as a restoring spring, is preloaded on the cylindrical section 4b. This is adapted to rotate the rotary shaft 10.

FIG. 7 shows a detailed view of a suspension device 4. This has a bearing point (bore) 4a and a filigree cylindrical section 4b which has a plurality of steps.

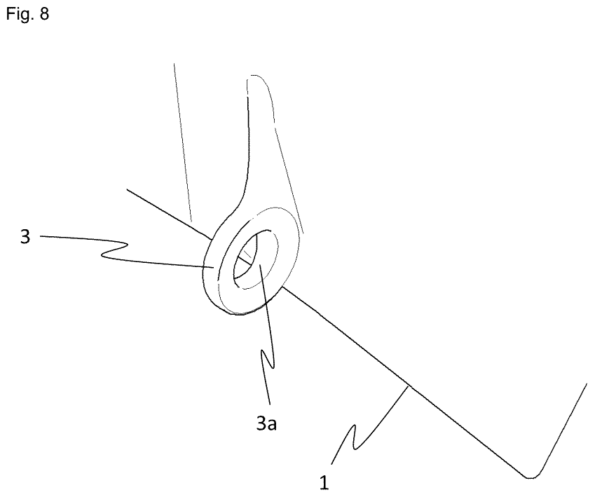

FIG. 8 shows a detailed view of a fastening device 3 with an interface (here: bore) 3a, which is provided integrally with the frame 1.

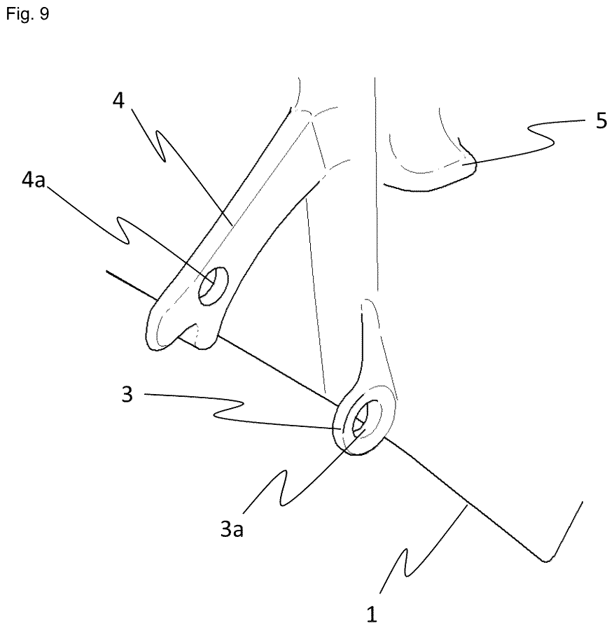

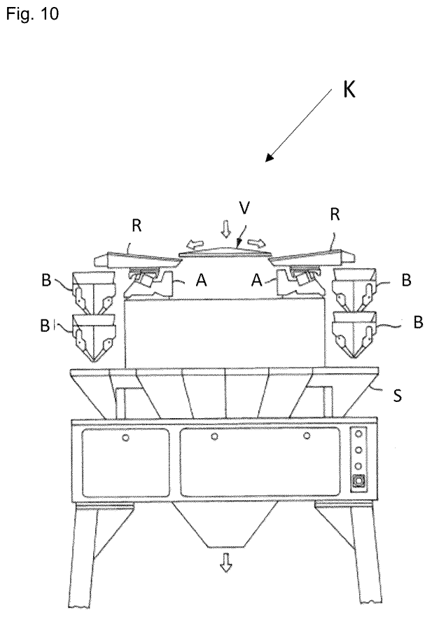

FIG. 9 shows a detailed view of a fastening device 3 with an interface (here: bore) 3a, a suspension device 4 with a bearing point (bore) 4a, and a limiting section 5. The limiting section 5 limits the movement of the flap actuating mechanism 9, as shown in FIG. 6.

FIG. 10 shows a detailed view of a combination scale K.

Materials to be weighed can be distributed on metering channels R by a distribution plate V. These are driven in each case by a drive A. Material to be weighed falls from there into a first container B (this serves as a storage container in the present embodiment) and from there into a container B arranged thereunder (this serves as a weighing container in the present embodiment). From there, the material to be weighed can fall into a collecting device S, configured here as a funnel.

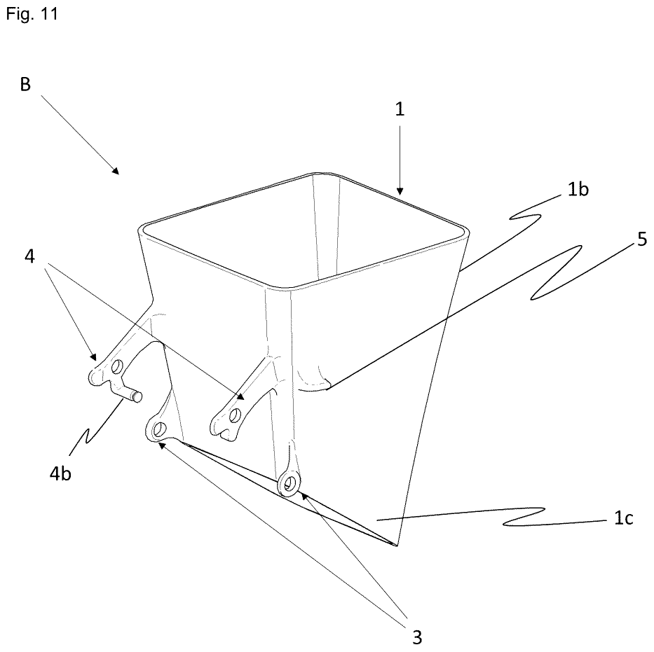

FIG. 11 shows a frame 1 of a container B according to a second embodiment. The container frame is configured from precision casting, an upper part (duct-shaped section 1b) is square or cube-shaped, a lower part (section 1c adapted to the flap shape) is prism-shaped with a tapering part. Flap fastening devices 3, to which a flap (not shown here) can be attached, are provided on one side on the outer side of the frame 1. Thus, only one flap is provided here. Furthermore, two suspension devices 4 are provided. A suspension device 4 has a cylindrical section 4b (to which, for example, a restoring spring—not shown here—can be fastened).

The present invention is not restricted to the abovementioned specific embodiments. In addition to the sections already described, further sections can also be formed integrally with the frame. The combination scale can also have other embodiments.

The following points relate to the disclosure of the present invention:

1. Container (B) having a frame (1), wherein the frame (1) is produced from a metal material, wherein the frame (1) has no welding connections.

2. Container (B) according to item 1, wherein the frame (1) is produced from a ductile metal material.

3. Container (B) according to item 1 or 2, wherein the frame (1) is produced from stainless steel.

4. Container (B) according to one of the preceding items, wherein the frame (1) is produced by a primary forming method, preferably a casting method, more preferably a precision casting method.

5. Container (B) according to one of the preceding items, wherein the frame (1) has a duct-shaped portion (1b).

6. Container (B) according to item 5, which furthermore has a section (1c) adapted to the flap shape, which is attached to the duct-shaped section (1b), wherein the section (1c) adapted to the flap shape is preferably obliquely tapering.

7. Container (B) according to one of the preceding items, wherein the frame (1) is formed in one piece.

8. Container (B) according to one of the preceding items, wherein the wall thickness of the frame (1) is in the range between 0.3 and 5 mm, preferably 1 and 2.5 mm.

9. Container (B) according to one of the preceding items, wherein the average roughness of the frame surface is at most 0.8 μm.

10. Container (B) according to one of the preceding items, wherein a surface structuring (2) is provided on the inner side (la) of the frame (1).

11. Container (B) according to item 10, wherein the surface structuring is diamond-shaped.

12. Container (B) according to one of the preceding items, wherein at least one flap fastening device (3) is provided on the outer side of the frame (1).

13. Container (B) according to one of the preceding items, wherein at least four flap fastening devices (3) are provided on the outer side of the frame (1).

14. Container (B) according to one of items 12 and 13, wherein the flap fastening devices (3) have a section projecting from the frame (1), which respectively has an interface (3a).

15. Container (B) according to one of items 12 to 14 when referring back to item 5, wherein the flap fastening devices (3) are provided at the transition from the duct-shaped section (1b) to an acute-angled section (1c).

16. Container (B) according to one of items 1 to 15, wherein the frame (1) has at least one suspension device (4).

17. Container (B) according to item 16, wherein the frame (1) has two suspension devices (4).

18. Container (B) according to one of items 16 or 17, wherein the suspension device(s) (4) each have a bearing point (4a).

19. Container (B) according to one of items 16 to 18, wherein at least one suspension device (4) has a cylindrical portion (4b).

20 Container (B) according to one of items 12 to 19, wherein the transitions between the outer side of the frame (1) and the flap fastening devices (3) have a radius of at least 6.5 mm.

21. Container (B) according to one of items 16 to 19, wherein the transitions between the outer side of the frame (1) and the suspension device(s) (4) have a radius of at least 6.5 mm.

22. Container (B) according to one of the preceding items, furthermore having: at least one flap (6, 7) which is adapted to close the lower opening of the container (B), wherein the at least one flap (6, 7) is mounted pivotably on at least one, preferably in each case two flap fastening device(s) (3), and one flap (6, 7) is connected by a flap actuating mechanism (9) to a rotary shaft (10), wherein the rotary shaft (10) is mounted in the bearing points (4a) of the suspension devices (4), wherein preferably two flaps (6, 7) are provided, which are connected to one another by a connecting element (8).

23. Container (B) according to item 22 when referring back to item 6, wherein the flap(s) (6, 7) bear against the parts of the section (1c) adapted to the flap shape.

24 Container (B) according to one of items 22 or 23, wherein the movement of the flap actuating mechanism (9) upwards is limited by a limiting section (5) which is formed integrally with the frame (1).

25. Container (B) according to one of items 22 to 24, wherein the frame (1) has a greater wall thickness in the region where the suspension devices (4) are provided than in other regions.

26. Combination scale (K), having a plurality of weighing containers (B) and optionally storage containers (B) according to one of the preceding items, and a collecting device(S) which is adapted to bring together products from the weighing containers (B), wherein the weighing containers (B) are adapted to record a weight signal over time.

27. Combination scale (K) according to item 26, furthermore having a distribution plate (V) and a plurality of metering channels (R), which are provided in each case with a drive (A), which are provided above the weighing containers (B).

28. Method for producing a frame (1) of a container (B), comprising the following steps: a) providing an outer casting mold (F) which images the outer surface of the frame (1); b) providing a casting core (T) adapted to image the inner surface of the frame (1); c) arranging the casting core (T) in the outer casting mold (F); d) filling the outer casting mold (F) with material.

29 Method according to item 28, wherein a surface structure (2) is provided at least partially on the casting core (T).

### LIST OF REFERENCE SIGNS

B Container
1 Frame
1a Inner side
1b Duct-shaped section
1c section adapted to flap shape/obliquely tapering section
2 structure
3 flap fastening device
3a interface/bore
4 suspension device
4a bearing point/bore
4b cylindrical section
5 limiting section
6 first flap
7 second flap
8 connecting element
9 flap actuating mechanism
10 rotary shaft
K combination scale
V distribution plate
A drive
R metering channel
S collecting funnel
H Holding device
D Spring
F outer casting mold
T casting core

Although the invention has been described in detail with reference to certain preferred embodiments, variations and modifications exist within the scope and spirit of one or more independent aspects of the invention as described.

What is claimed is:

1. A container, comprising:
a frame,
wherein the frame is produced from a metal material,
wherein the frame has no welding connections.

2. The container according to claim 1, wherein the frame is produced from stainless steel.

3. The container according to claim 1, wherein the frame is produced by a primary forming method, preferably a casting method, more preferably a precision casting method.

4. The container according to claim 1, wherein the frame has a duct-shaped section.

5. The container according to claim 4, which furthermore has a section adapted to a flap shape, which is attached to the duct-shaped section.

6. The container according to claim 1, wherein the frame is formed in one piece.

7. The container according to claim 1, wherein a surface structuring is provided on an inner side of the frame.

8. The container according to claim 1, wherein at least one flap fastening device is provided on an outer side of the frame.

9. The container according to claim 1, wherein the frame has at least one suspension device.

10. The container according to claim 8, further comprising:
at least one flap which is adapted to close a lower opening of the container,
wherein the at least one flap is mounted pivotably on the at least one flap fastening device,
wherein the at least one flap is connected by a flap actuating mechanism to a rotary shaft, wherein the rotary shaft is mounted in bearing points of a suspension device of the frame.

11. The container according to claim 10, wherein the at least one flap includes two flaps that are connected to one another by a connecting element.

12. The container according to claim 10, wherein movement of the flap actuating mechanism is limited by a limiting section which is formed integrally with the frame.

13. The container according to claim 9, further comprising:
at least one flap which is adapted to close a lower opening of the container,
wherein the at least one flap is mounted pivotably on the at least one flap fastening device,
wherein the at least one flap is connected by a flap actuating mechanism to a rotary shaft, wherein the rotary shaft is mounted in bearing points of a suspension device of the frame.

14. The container according to claim 13, wherein the at least one flap includes two flaps that are connected to one another by a connecting element.

15. The container according to claim 13, wherein movement of the flap actuating mechanism is limited by a limiting section which is formed integrally with the frame.

16. A combination scale comprising:
a plurality of weighing containers, each weighing container including a frame, wherein each frame is produced from a metal material, and wherein each frame has no welding connections; and
a collecting device which is adapted to bring together products from the weighing containers,
wherein the weighing containers are adapted to record a weight signal over time.

17. The combination scale according to claim 16, further comprising:
a distribution plate and a plurality of metering channels, which are respectively provided with a drive, which are provided above the weighing containers.

18. The combination scale according to claim 16, further comprising a plurality of storage containers, wherein each storage container includes a frame, wherein each frame is produced from a metal material, and wherein each frame has no welding connections.

19. A method for producing a frame of a container, the method comprising:
a) providing an outer casting mold which images an outer surface of the frame;
b) providing a casting core adapted to image an inner surface of the frame;
c) arranging the casting core in the outer casting mold; and
d) filling the outer casting mold with material.

20. The method according to claim 19, wherein a surface structure is provided at least partially on the casting core.
